(19) United States
(12) Patent Application Publication
(10) Pub. No.: US 2019/0155243 A1
(43) Pub. Date: May 23, 2019

(54) PROGRAM COMPARING DEVICE AND PROGRAM COMPARING METHOD

(71) Applicant: FANUC CORPORATION, Yamanashi (JP)

(72) Inventors: Yasuyuki INO, Yamanashi-ken (JP); Mitsuru MOCHIZUKI, Yamanashi-ken (JP)

(21) Appl. No.: 16/191,705

(22) Filed: Nov. 15, 2018

(30) Foreign Application Priority Data
Nov. 20, 2017 (JP) 2017-222755

(51) Int. Cl. G05B 19/05; G06F 9/30

(52) U.S. Cl. CPC G05B 19/058; G06F 9/30021; G05B 19/056

(57) ABSTRACT

A program comparing device that compares programs described by ladder diagrams includes: a logical expression converting unit configured to convert a ladder circuit of the program into a logical expression, in units of the ladder circuit; an order converting unit configured to rearrange an order of variables of the logical expression of at least one ladder circuit, of two of the ladder circuits that are comparison targets, so as not to change a result of the logical expression; and a comparing unit configured to compare the logical expression of the one ladder circuit after the order of the variables has been rearranged, with a logical expression of another ladder circuit of the two of the ladder circuits, and judge whether or not they match.

### CROSS-REFERENCE TO RELATED APPLICATION

This application is based upon and claims the benefit of priority from Japanese Patent Application No. 2017-222755 filed on Nov. 20, 2017, the contents of which are incorporated herein by reference.

### BACKGROUND OF THE INVENTION

### Field of the Invention

The present invention relates to a program comparing device and a program comparing method that compare two programs described by ladder diagrams.

### Description of the Related Art

Japanese Laid-Open Patent Publication No. 2016-118883 discloses a program retrieving device that judges whether or not two signals and a logical operation relationship between these two signals are included in a program.

### SUMMARY OF THE INVENTION

In the program retrieving device described in Japanese Laid-Open Patent Publication No. 2016-118883, although a specific signal and logical operation relationship in the program can be retrieved, a comparison of ladder circuits cannot be performed. Up to now, when performing a comparison of ladder circuits, it has been judged whether or not structures of the ladder circuits match with each other. However, in this method of judging, even substantively identical ladder circuits that although structures of the ladder circuits differ, outputs with respect to a signal inputted to the ladder circuits match, are judged to be non-matching. Since ladder circuits that have been judged non-matching need to undergo testing, and so on, there has been a risk of unnecessary work increasing.

The present invention has been made to solve the above-described problem, and has an object of providing a program comparing device and a program comparing method by which it can be judged whether or not ladder circuits substantively match with each other.

A first aspect of the present invention is a program comparing device that compares programs described by ladder diagrams, including: a logical expression converting unit configured to convert a ladder circuit of the program into a logical expression, in units of the ladder circuit; an order converting unit configured to rearrange an order of signals of the logical expression of at least one ladder circuit, of two of the ladder circuits that are comparison targets, so as not to change a result of the logical expression; and a comparing unit configured to compare the logical expression of the one ladder circuit after the order of the signals has been rearranged, with a logical expression of another ladder circuit of the two of the ladder circuits, and judge whether or not the logical expression of the one ladder circuit and the logical expression of the other ladder circuit match.

A second aspect of the present invention is a program comparing method that compares programs described by ladder diagrams, including: a logical expression converting step of converting a ladder circuit of the program into a logical expression, in units of the ladder circuit; an order converting step of rearranging an order of signals of the logical expression of at least one ladder circuit, of two of the ladder circuits that are comparison targets, so as not to change a result of the logical expression; and a comparing step of comparing the logical expression of the one ladder circuit after the order of the signals has been rearranged, with a logical expression of another ladder circuit of the two of the ladder circuits, and judge whether or not the logical expression of the one ladder circuit and the logical expression of the other ladder circuit match.

The present invention makes it possible to perform a comparison of whether or not two ladder circuits match.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing a configuration of a program comparing device;

FIG. 2A is a view showing a ladder circuit, and FIG. 2B is a view showing a logical expression;

FIG. 3 is a view for explaining an outline of processing performed by the program comparing device;

FIG. 4 is a flowchart showing a flow of program comparison processing performed by the program comparing device;

FIG. 5 is a flowchart showing a flow of program comparison processing performed by the program comparing device;

FIG. 6 is a flowchart showing a flow of comparison-oriented logical expression conversion processing;

FIGS. 7A, 7B and 7C are views explaining the comparison-oriented logical expression conversion processing;

FIGS. 8A, 8B and 8C are views explaining the comparison-oriented logical expression conversion processing;

FIGS. 9A, 9B and 9C are views explaining the comparison-oriented logical expression conversion processing;

FIG. 10 is a flowchart showing a flow of logical expression comparison processing;

FIG. 11 is a flowchart showing a flow of logical expression comparison processing;

FIGS. 12A and 12B are views explaining the logical expression comparison processing;

FIGS. 13A and 13B are views explaining the logical expression comparison processing;

FIGS. 14A and 14B are views explaining the logical expression comparison processing;

FIGS. 15A and 15B are views explaining the logical expression comparison processing; and

FIGS. 16A and 16B are views explaining the logical expression comparison processing.

### DESCRIPTION OF THE PREFERRED EMBODIMENTS

### First Embodiment

### [Configuration of Program Comparing Device]

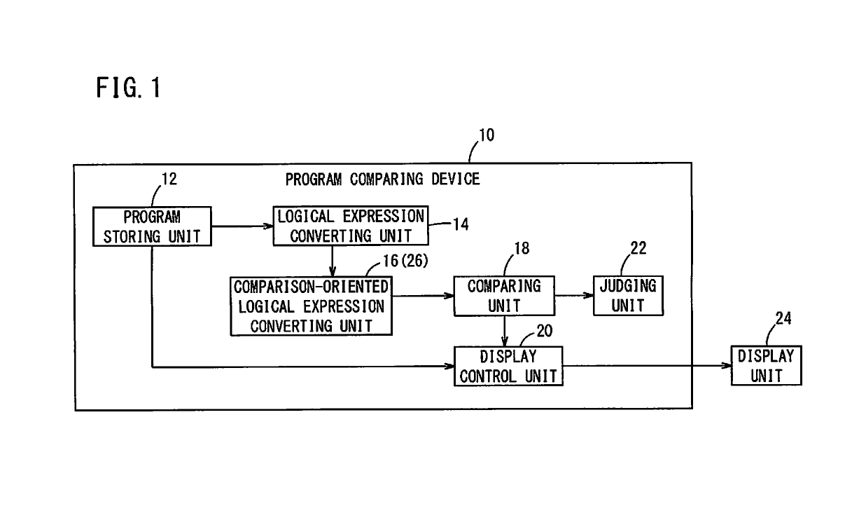

FIG. 1 is a block diagram showing a configuration of a program comparing device 10. The program comparing device 10 of the present embodiment is a personal computer, or the like. The program comparing device 10 compares programs described by ladder diagrams (hereafter, such programs will be referred to as ladder programs), and judges whether or not two ladder programs match. The ladder program is configured from a plurality of ladder circuits. The program comparing device 10 compares the ladder programs in units of the ladder circuit. Sometimes, outputs with respect to a signal inputted to two ladder circuits match, even when structures of the two ladder circuits differ. The program comparing device 10 of the present embodiment judges that two ladder circuits match in the case of them being ladder circuits whose outputs with respect to an inputted signal match.

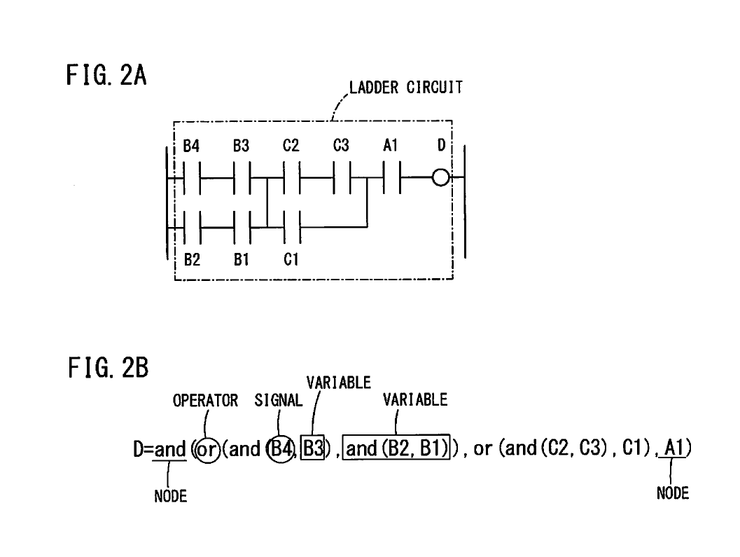

Now, terminology employed in the present embodiment will be described. FIG. 2A is a view showing a ladder circuit. FIG. 2B is a view showing a logical expression. Note that FIG. 2B shows the ladder circuit of FIG. 2A converted into a logical expression.

As shown in FIG. 2A, in the present embodiment, a circuit configured by a switch or relay (“A1”, “B1”, and so on, in FIG. 2A) for activating a coil (“D” in FIG. 2A) will be referred to as the “ladder circuit”. A term “and” or “or” of the logical expression shown in FIG. 2B will be referred to as an “operator”. In the logical expression, “A1”, “B1”, and so on, corresponding to the relay or switch of the ladder circuit will be referred to as a “signal”. A value inputted to the operator will be referred to as a “variable”. For example, “and (C2, C3)” and “C1” inputted to the final “or” of FIG. 2B are both “variables”, and the individual “C1”, “C2”, “C3” are also signals. Moreover, a single “operator” and “signal” will be referred to as a “node”.

The program comparing device 10 includes a program storing unit 12, a logical expression converting unit 14, a comparison-oriented logical expression converting unit 16, a comparing unit 18, a display control unit 20, and a judging unit 22 (FIG. 1). Each of configurations of the program comparing device 10 will be described below.

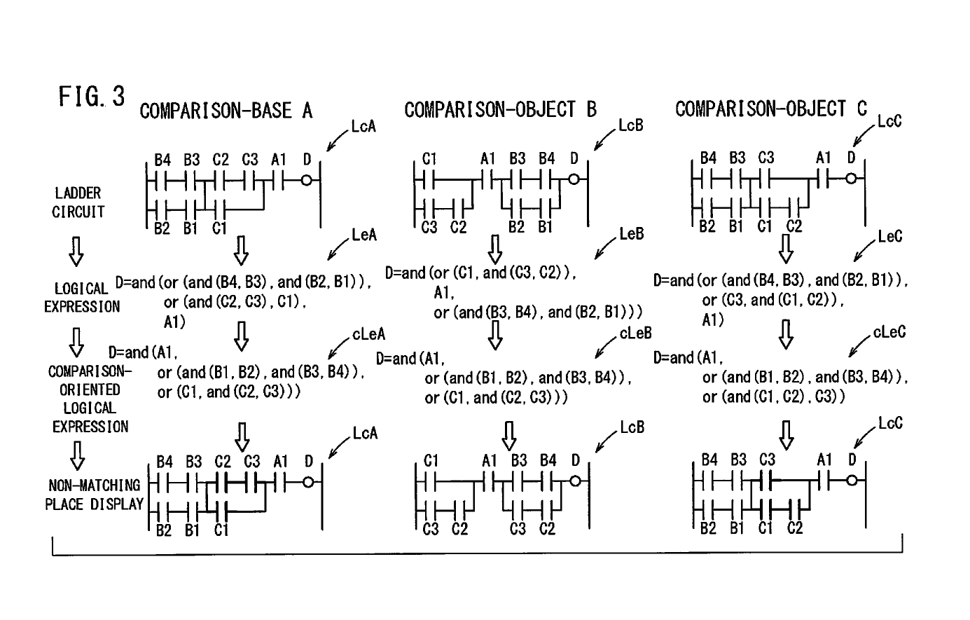

FIG. 3 is a view for explaining an outline of processing performed by the program comparing device 10. A ladder circuit LcA of FIG. 3 is a ladder circuit of a ladder program to which comparison is being made (hereafter, referred to as a comparison-base ladder program or comparison-base). A ladder circuit LcB and a ladder circuit LcC are ladder circuits of ladder programs that are being compared (hereafter, referred to as comparison-object ladder programs or comparison-objects). In FIG. 3, processing on the ladder circuit LcA is shown in a comparison-base A column, processing on the ladder circuit LcB is shown in a comparison-object B column, and processing on the ladder circuit LcC is shown in a comparison-object C column. The ladder circuit LcA and the ladder circuit LcB are substantively identical ladder circuits that although structures of the ladder circuits differ, outputs with respect to a signal inputted to both ladder circuits match. On the other hand, the ladder circuit LcA and the ladder circuit LcC have non-matching outputs with respect to a signal inputted to both ladder circuits, hence are different ladder circuits even in a substantive sense.

The program storing unit 12 of the program comparing device 10 stores the ladder programs. The logical expression converting unit 14 reads the ladder program to which comparison is being made (hereafter, referred to as the comparison-base ladder program) and the ladder program that is being compared (hereafter, referred to as the comparison-object ladder program) from the program storing unit 12, and converts them into respective logical expressions in units of a ladder circuit of the read comparison-base ladder program and comparison-object ladder program. In the example of FIG. 3, the logical expression converting unit 14 respectively converts the ladder circuits LcA, LcB, LcC into logical expressions LeA, LeB, LeC.

The comparison-oriented logical expression converting unit 16 rearranges the logical expression converted by the logical expression converting unit 14, according to a certain rule of the logical expression, thereby converting the logical expression into a comparison-oriented logical expression. In the example of FIG. 3, the comparison-oriented logical expression converting unit 16 converts the logical expressions LeA, LeB, LeC into the comparison-oriented logical expressions cLeA, cLeB, cLeC. Note that the comparison-oriented logical expression converting unit 16 functions as an order converting unit 26. The comparing unit 18 judges whether or not two logical expressions that have been rearranged by the comparison-oriented logical expression converting unit 16 match.

The display control unit 20 controls a display unit 24 so as to display the ladder circuits LcA, LcB, LcC. The display control unit 20 controls the display unit 24 so as to highlight a place corresponding to a non-matched portion of the two logical expressions compared by the comparing unit 18, in the ladder circuit LcA of the comparison-base A and the ladder circuit LcC of the comparison-object C. In the example shown in FIG. 3, places corresponding to terms “C1”, “C2”, and “C3” of the ladder circuit LcA of the comparison-base A and the ladder circuit LcC of the comparison-object C are highlighted by bold lines. Note that highlighting is not limited to being by bold lines and bold characters, and a configuration may be adopted whereby a color is changed. Moreover, a configuration may be adopted whereby only highlighting of the ladder circuit LcC of the comparison-object C is performed, without highlighting being performed in the ladder circuit LcA of the comparison-base A.

The judging unit 22 judges whether or not the comparison-base ladder program and the comparison-object ladder program match, based on a judgment result in the comparing unit 18.

### [Program Comparison Processing]

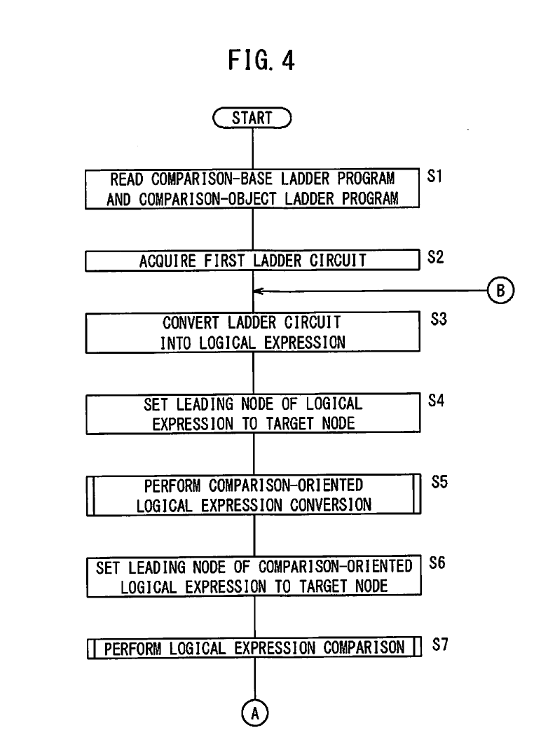

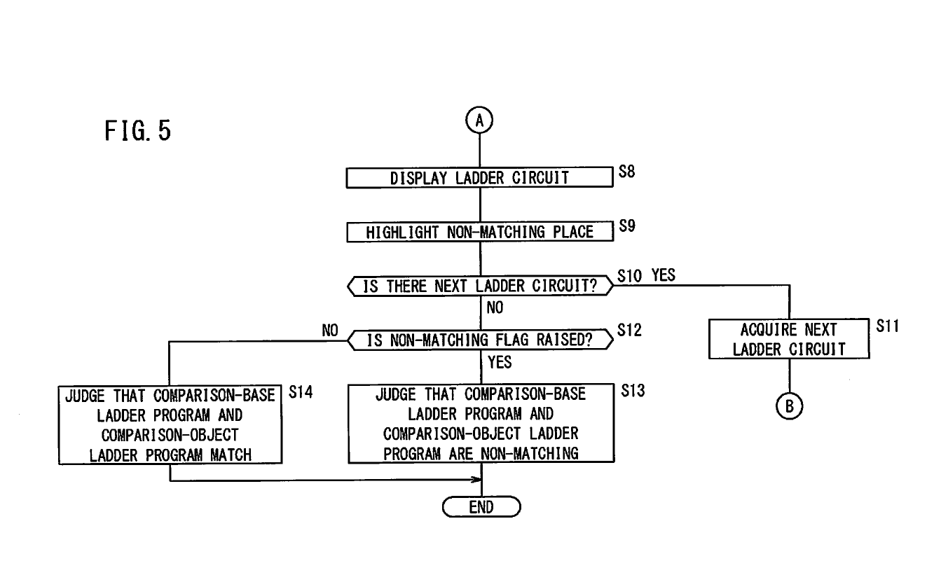

FIGS. 4 and 5 are flowcharts showing a flow of program comparison processing performed by the program comparing device 10. Although a simple comparison processing that does not consider deletion of a ladder circuit or insertion of a new ladder circuit is described here, it is possible to employ a generally implemented comparison processing where deletion or insertion is detected by comparing also fellow ladder circuits having different positions.

In step S1, the comparison-base ladder program and the comparison-object ladder program are read from the program storing unit 12 by the logical expression converting unit 14, after which processing shifts to step S2. In step S2, a first ladder circuit is acquired from each of the read comparison-base ladder program and comparison-object ladder program by the logical expression converting unit 14, after which processing shifts to step S3.

In step S3, the acquired ladder circuit is converted into a logical expression by the logical expression converting unit 14, after which processing shifts to step S4. In step S4, a leading node of the converted logical expression is set to a target node by the comparison-oriented logical expression converting unit 16, after which processing shifts to step S5.

In step S5, comparison-oriented logical expression conversion processing is performed by the comparison-oriented logical expression converting unit 16, after which processing shifts to step S6. The comparison-oriented logical expression conversion processing converts the read logical expression into a comparison-oriented logical expression. Moreover, the comparison-oriented logical expression conversion processing returns the comparison-oriented logical expression as a return value. The comparison-oriented logical expression conversion processing will be mentioned in detail later.

In step S6, a leading node of the comparison-oriented logical expression of the comparison-base is set to a target node A, and a leading node of the ladder circuit of the comparison-object is set to a target node B, by the comparing unit 18, after which processing shifts to step S7.

In step S7, logical expression comparison processing is performed by the comparing unit 18, after which processing shifts to step S8. The logical expression comparison processing compares the comparison-oriented logical expression of the comparison-base and the comparison-oriented logical expression of the comparison-object, and returns a non-matching flag as a return value. When the comparison-oriented logical expression of the comparison-base and the comparison-oriented logical expression of the comparison-object match, the non-matching flag is lowered, and when they do not match, the non-matching flag is raised. The logical expression comparison processing will be mentioned in detail later.

In step S8, the display unit 24 is controlled by the display control unit 20 so as to display the ladder circuit of the comparison-base and the ladder circuit of the comparison-object, after which processing shifts to step S9. In step S9, the display unit 24 is controlled by the display control unit 20 such that a place corresponding to a node assigned with a non-matching mark is highlighted by a bold line on the ladder circuit of the comparison-base and the ladder circuit of the comparison-object displayed in the display unit 24, after which processing shifts to step S10. The non-matching mark will be mentioned in detail later.

In step S10, it is judged whether or not there is a next ladder circuit in the comparison-base ladder program and the comparison-object ladder program. In the case there is a next ladder circuit, processing shifts to step S11, and in the case there is not a next ladder circuit, processing shifts to step S12.

In step S11, the next ladder circuit is acquired from each of the read comparison-base ladder program and comparison-object ladder program by the logical expression converting unit 14, after which processing returns to step S3. In step S12, it is judged by the judging unit 22 whether or not the non-matching flag in a raised state has been returned by the logical expression comparison processing of step S7. In the case that the non-matching flag in the raised state has been returned from the logical expression comparison processing, processing shifts to step S13, and in the case that the non-matching flag in the raised state is not returned from the logical expression comparison processing, processing shifts to step S14.

In step S13, it is judged by the judging unit 22 that the comparison-base ladder program and the comparison-object ladder program are non-matching, after which processing is ended. In step S14, it is judged by the judging unit 22 that the comparison-base ladder program and the comparison-object ladder program match, after which processing is ended.

### [Comparison-Oriented Logical Expression Conversion Processing]

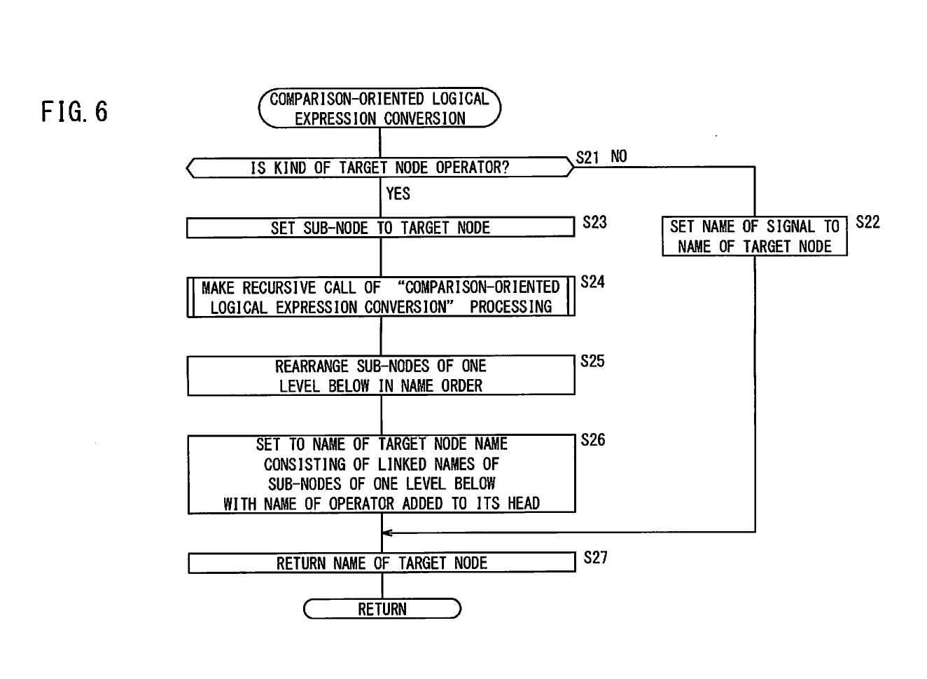

FIG. 6 is a flowchart showing a flow of the comparison-oriented logical expression conversion processing performed by the comparison-oriented logical expression converting unit 16 in step S5 of FIG. 4. In step S21, it is judged whether or not a kind of the target node is an operator. When the kind of the target node is an operator, processing shifts to step S23, and when the kind of the target node is a signal, processing shifts to step S22.

In step S22, a name of the signal is set to a name of the target node, after which processing shifts to step S27. In step S23, all sub-nodes (child nodes) of one level below are set to the target nodes, after which processing shifts to step S24. In step S24, the comparison-oriented logical expression conversion processing is called recursively for each of the target nodes, after which processing shifts to step S25.

In step S25, the sub-nodes of one level below are rearranged in a name order of return values, after which processing shifts to step S26. A rule of the name order is assumed to be, for example, that names of signals are in alphabetical order and numerical order, moreover, a name configured from a signal alone is before a name including an operator, moreover, a name headed by “and” is before one headed by “or”.

In step S26, a name consisting of linked return values of the sub-nodes of one level below with the name of the operator of the target node added to its head, is set to the name of the target node, after which processing shifts to step S27. In step S27, the name of the target node is returned as a return value, after which processing is ended.

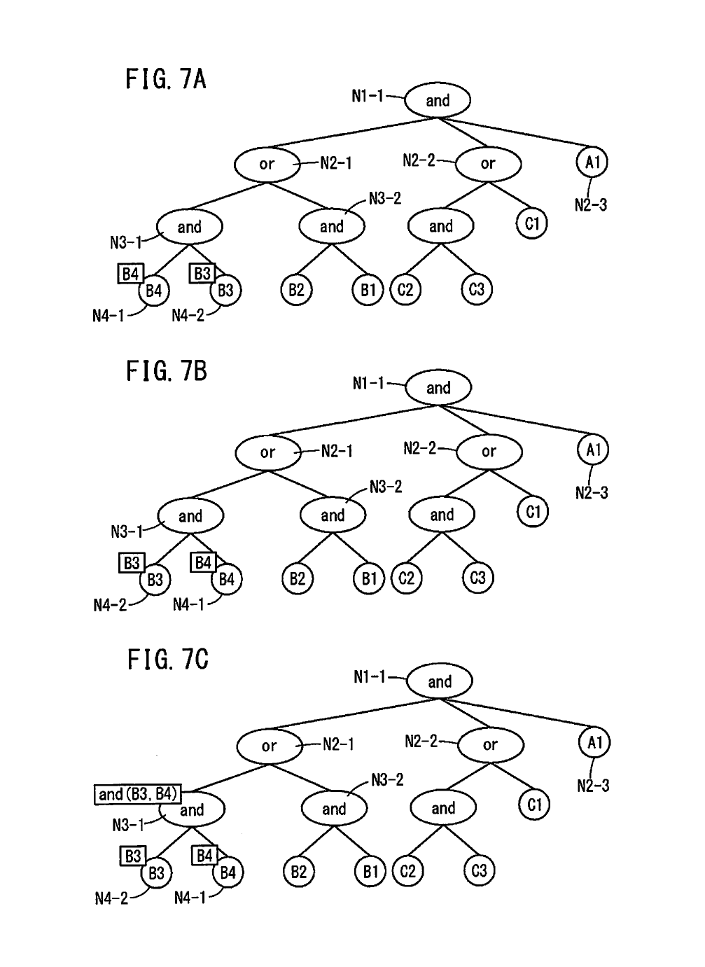

FIGS. 7A to 7C, 8A to 8C, and 9A to 9C are views explaining the comparison-oriented logical expression conversion processing. In FIGS. 7A to 7C, 8A to 8C, and 9A to 9C, for explanation, the logical expression is shown by a tree structure. FIGS. 7A to 7C, 8A to 8C, and 9A to 9C show an example where the logical expression LeA shown in FIG. 3 is converted to the comparison-oriented logical expression cLeA shown in FIG. 3.

In a first cycle comparison-oriented logical expression conversion processing, the target node is set to node N1-1. Node N1-1 is an operator, hence comparison-oriented logical expression conversion processing is called for nodes in a lower level in step S24. When node N4-1 is set as the target node, then, in step S22, a name B4 of a signal is set as a name of node N4-1. Then, in step S27, the name B4 of node N4-1 is returned as a return value (FIG. 7A). Similarly, when node N4-2 is set as the target node, then, a name of node N4-2 is set to a name B3 of a signal, and the name B3 of node N4-2 is returned as a return value (FIG. 7A).

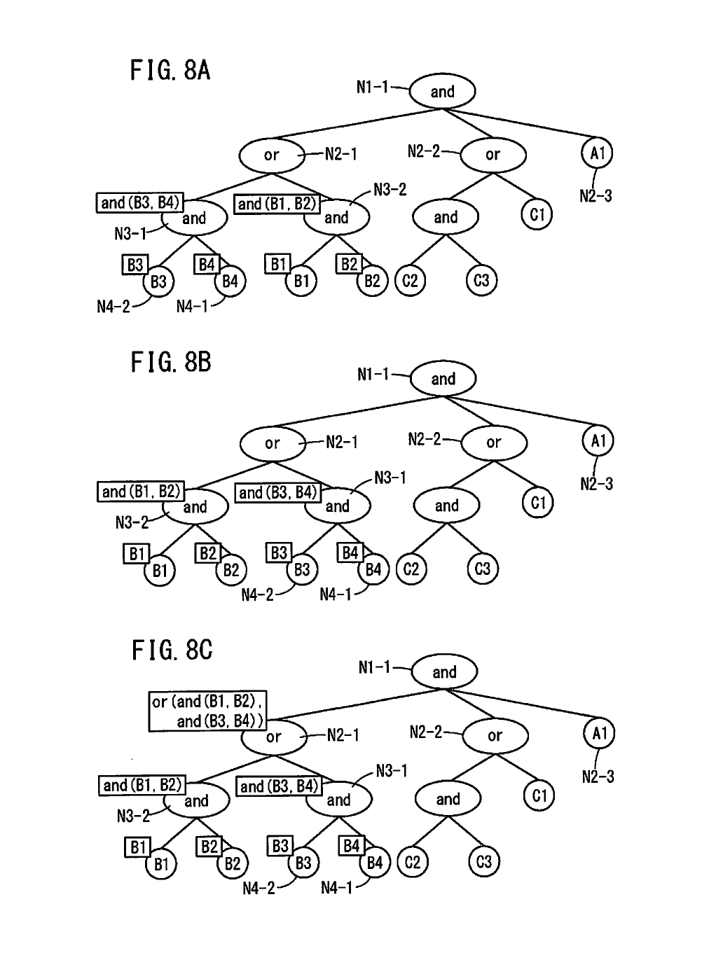

When the comparison-oriented logical expression conversion processing where node N4-1 and node N4-2 are the target nodes is ended, then, in step S25 of the comparison-oriented logical expression conversion processing where node N3-1 has been set as the target node, the sub-nodes of one level below are rearranged in the name order of the sub-nodes (FIG. 7B). Then, in step S26, a name consisting of linked names of the sub-nodes of one level below with the name of the operator of node N3-1 added to its head, that is, a name (and (B3, B4)) is set as the name of node N3-1. In following step S27, the name (and (B3, B4)) of node N3-1 is returned (FIG. 7C). Similarly also in the comparison-oriented logical expression conversion processing where node N3-2 has been set as the target node, (and (B1, B2) is set as a name of node N3-2, and the name (and (B1, B2)) of node N3-2 is returned (FIG. 8A).

In step S25 of the comparison-oriented logical expression conversion processing where node N2-1 has been set as the target node, the sub-nodes of one level below are rearranged in the name order of the sub-nodes (FIG. 8B). Then, in step S26, a name consisting of linked names of the sub-nodes of one level below with the name of the operator of node N2-1 added to its head, that is, a name (or (and (B1, B2), and (B3, B4))) is set as the name of node N2-1. In following step S27, the name (or (and (B1, B2), and (B3, B4))) of node N2-1 is returned (FIG. 8C).

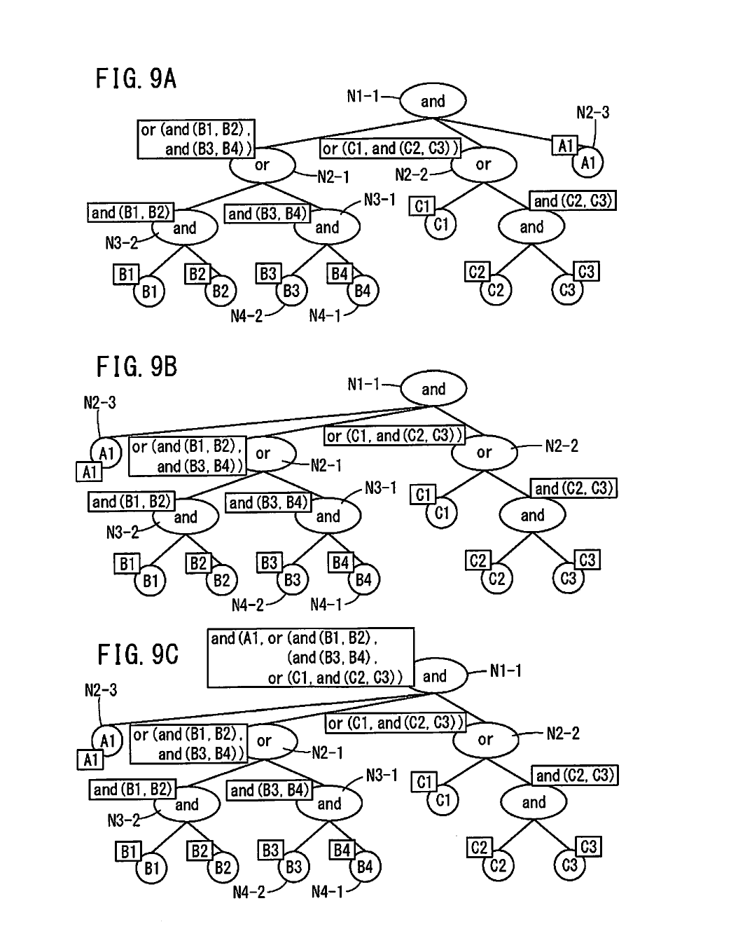

Similarly, the comparison-oriented logical expression conversion processing is executed also on each of the nodes in a level below node N2-2. As a result, (or (C1, and (C2, C3))) is set to a name of node N2-2, and the name (or (C1, and (C2, C3))) of node N2-2 is returned. In addition, the comparison-oriented logical expression conversion processing is executed on node N2-3, (A1) is set to a name of node N2-3, and the name (A1) of node N2-3 is returned (FIG. 9A).

In step S25 of the comparison-oriented logical expression conversion processing where node N1-1 has been set as the target node, the sub-nodes of one level below are rearranged in the name order of the sub-nodes (FIG. 9B). Then, in step S26, a name consisting of linked names of the sub-nodes of one level below with the name of the operator of node N1-1 added to its head, that is, a name (and (A1, or (and (B1, B2), and (B3, B4)), or (C1, and (C2, C3))) is set as the name of node N1-1. In following step S27, the name (and (A1, or (and (B1, B2), and (B3, B4)), or (C1, and (C2, C3))) of node N1-1 is returned (FIG. 9C).

### [Logical Expression Comparison Processing]

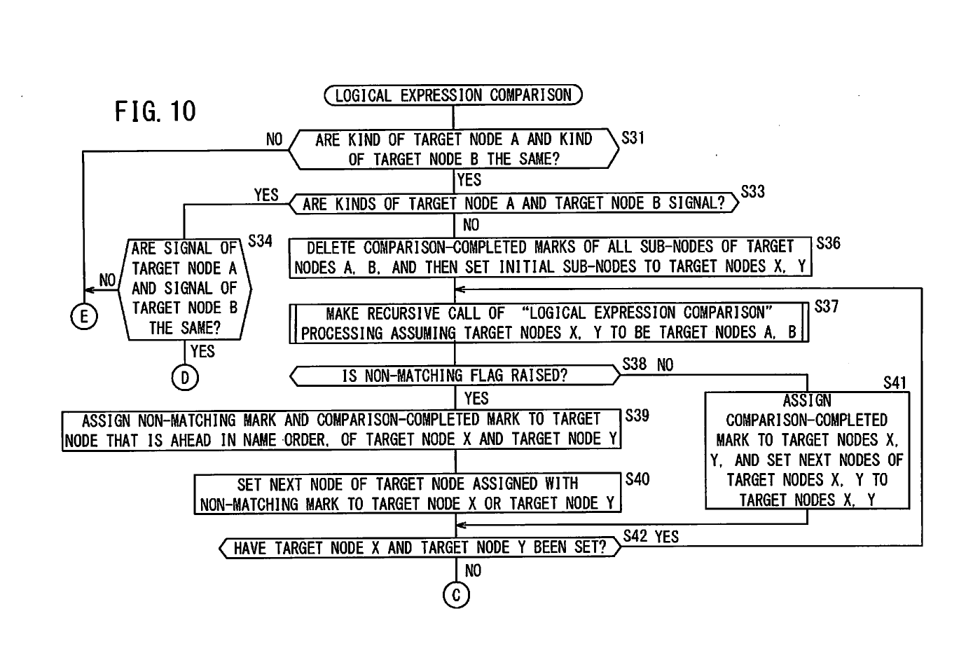

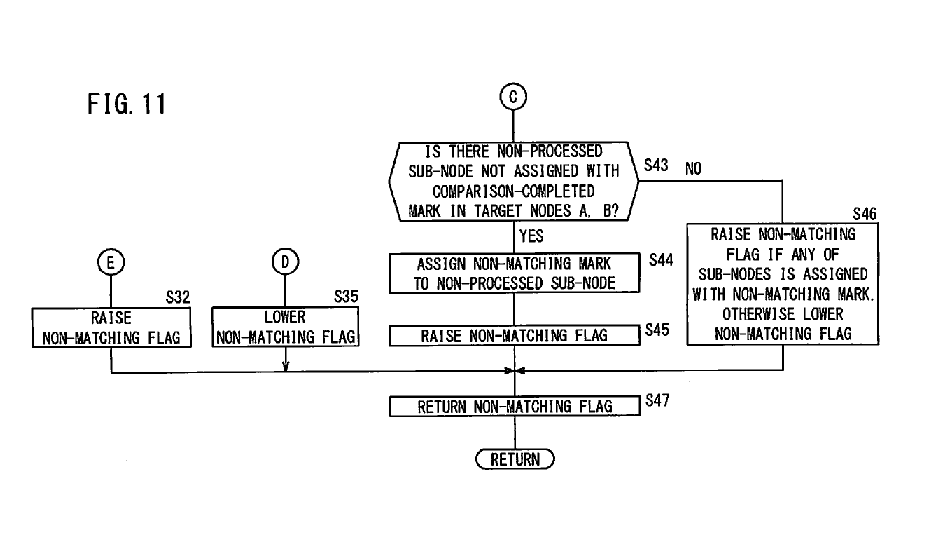

FIGS. 10 and 11 are flowcharts showing a flow of the logical expression comparison processing performed by the comparing unit 18 in step S7 of FIG. 4. In step S31, it is judged whether or not a kind of a target node A and a kind of a target node B are the same. In the case that the kind of the target node A and the kind of the target node B are the same, processing shifts to step S33, and in the case that the kind of the target node A and the kind of the target node B are not the same, processing shifts to step S32. In step S32, the non-matching flag is raised, after which processing shifts to step S47.

In step S33, it is judged whether or not the kind of the target node A and the kind of the target node B are signals. In the case that the kind of the target node A and the kind of the target node B are signals, processing shifts to step S34, and in the case that the kind of the target node A and the kind of the target node B are operators, processing shifts to step S36.

In step S34, it is judged whether a signal of target node A and a signal of target node B are the same. In the case that the signal of target node A and the signal of target node B are the same, processing shifts to step S35, and in the case that the signal of target node A and the signal of target node B are not the same, processing shifts to step S32. In step S35, the non-matching flag is lowered, after which processing shifts to step S47.

In step S36, the comparison-completed marks of all of the sub-nodes of target node A and target node B are deleted, and then an initial sub-node of target node A is set to target node X, and an initial sub-node of target node B is set to target node Y, after which processing shifts to step S37. In the example of the logical expression shown in FIG. 9C, the initial sub-node of node N1-1 is node N2-3.

In step S37, a recursive call of the logical expression comparison processing is made assuming target node X to be target node A and target node Y to be target node B, and processing shifts to step S38. In step S38, it is judged whether or not the non-matching flag is in a raised state. In the case that the non-matching flag is in a raised state, processing shifts to step S39, and in the case that the non-matching flag is in a lowered state, processing shifts to step S41.

In step S39, the name of target node X and the name of target node Y are compared, and the target node X or target node Y which is ahead in the name order is assigned with the non-matching mark and the comparison-completed mark, after which processing shifts to step S40. Since from the previously mentioned rule of the name order, a name configured from a signal alone is before a name including an operator, then in the case that, for example, the name of target node X is “C1” and the name of target node Y is “and (C1, C2)”, target node X is assigned with the non-matching mark and the comparison-completed mark.

In step S40, in the case that in step S39, target node X has been assigned with the non-matching mark, the next node of target node X is set to a new target node X, and in the case that in step S39, target node Y has been assigned with the non-matching mark, the next node of target node Y is set to a new target node Y, after which processing shifts to step S42. In step S41, the comparison-completed mark is assigned to target node X and target node Y, then the next node of target node X is set to a new target node X, and the next node of target node Y is set to a new target node Y, after which processing shifts to step S42. The next node indicates a neighboring node in the same level, and in the example of the logical expression shown in FIG. 9C, the next node of node N2-3 is node N2-1.

In step S42, it is judged whether or not target node X and target node Y have been set. In the case that target node X and target node Y have been set, processing returns to step S37, and in the case that target node X and target node Y have not been set, processing shifts to step S43. Target node X not having been set or target node Y not having been set indicates that since the next node does not exist, there was no node that should be set to target node X or target node Y. In the example of the logical expression shown in FIG. 9C, the next node does not exist in node N2-2, hence the next node of node N2-2 cannot be set to the target node.

In step S43, it is judged whether or not there is a non-processed sub-node in target node A and target node B. In the case of there being a non-processed sub-node, processing shifts to step S44, and in the case of there not being a non-processed sub-node, processing shifts to step S46. A non-processed sub-node indicates a sub-node not assigned with the comparison-completed mark, of the sub-nodes of target node A or target node B.

In step S44, all of the non-processed sub-nodes are assigned with the non-matching mark, after which processing shifts to step S45. In step S45, the non-matching flag is raised, after which processing shifts to step S47. In step S46, the non-matching flag is raised if any of the sub-nodes is assigned with the non-matching mark, and is lowered if none of the sub-nodes is assigned with the non-matching mark, after which processing shifts to step S47. In step S47, the non-matching flag is returned as a return value, after which processing is ended.

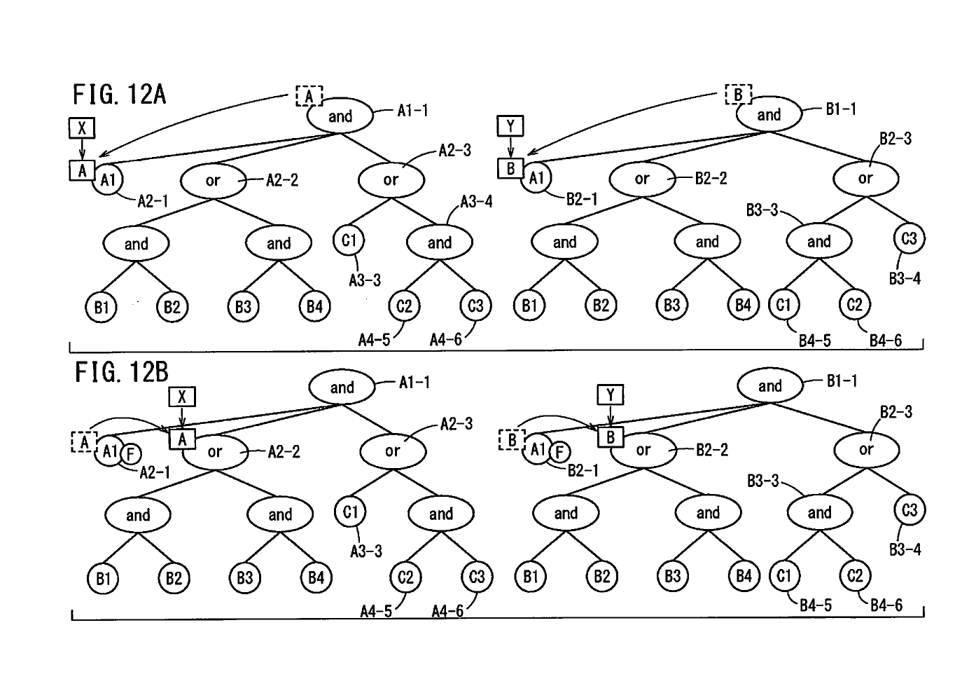

FIGS. 12A, 12B, 13A, 13B, 14A, 14B, 15A, 15B, 16A, and 16B are views explaining the logical expression comparison processing. In FIGS. 12A, 12B, 13A, 13B, 14A, 14B, 15A, 15B, 16A, and 16B, for explanation, the logical expression is shown by a tree structure. FIGS. 12A, 12B, 13A, 13B, 14A, 14B, 15A, 15B, 16A, and 16B show an example where the comparison-oriented logical expression cLeA of the comparison-base A and the comparison-oriented logical expression cLeC of the comparison-object C shown in FIG. 3 are compared. Moreover, in FIGS. 12A, 12B, 13A, 13B, 14A, 14B, 15A, 15B, 16A, and 16B, “F” indicates the comparison-completed mark, and “M” indicates the non-matching mark.

In a first cycle logical expression comparison processing, node A1-1 is set to target node A, and node B1-1 is set to target node B. Node A1-1 and node B1-1 are both the same operator “and”, so processing proceeds in the manner of step S31→step S33→step S36. In step S36, the comparison-completed marks of all of the sub-nodes A2-1, A2-2, A2-3, B2-1, B2-2, B2-3 of node A1-1 and node B1-1 are deleted, then node A2-1 being the initial sub-node of node A1-1 is set to target node X, and node B2-1 being the initial sub-node of node B1-1 is set to target node Y (FIG. 12A). In following step S37, a recursive call of the logical expression comparison processing is made assuming target node A to be node A2-1 and target node B to be node B2-1 (FIG. 12A).

Since node A2-1 and node B2-1 are the same signal “A1”, processing proceeds in the manner of step S31→step S33→step S34→step S35. In step S35, the non-matching flag is lowered, and in following step S47, that non-matching flag is returned as a return value.

The logical expression comparison processing where target node A is node A2-1 and target node B is node B2-1 ends, and processing proceeds in the manner of step S37→step S38. At this time, the non-matching flag is in a lowered state, so processing proceeds to step S41, and after node A2-1 and node B2-1 have been assigned with the comparison-completed mark, node A2-2 being the next node of node A2-1 is set to target node X, and node B2-2 being the next node of node B2-1 is set to target node Y (FIG. 12B). Since target node X and target node Y have been set, processing proceeds in the manner of step S42→step S37, and a recursive call of the logical expression comparison processing is made assuming target node A to be node A2-2 and target node B to be node B2-2 (FIG. 12B).

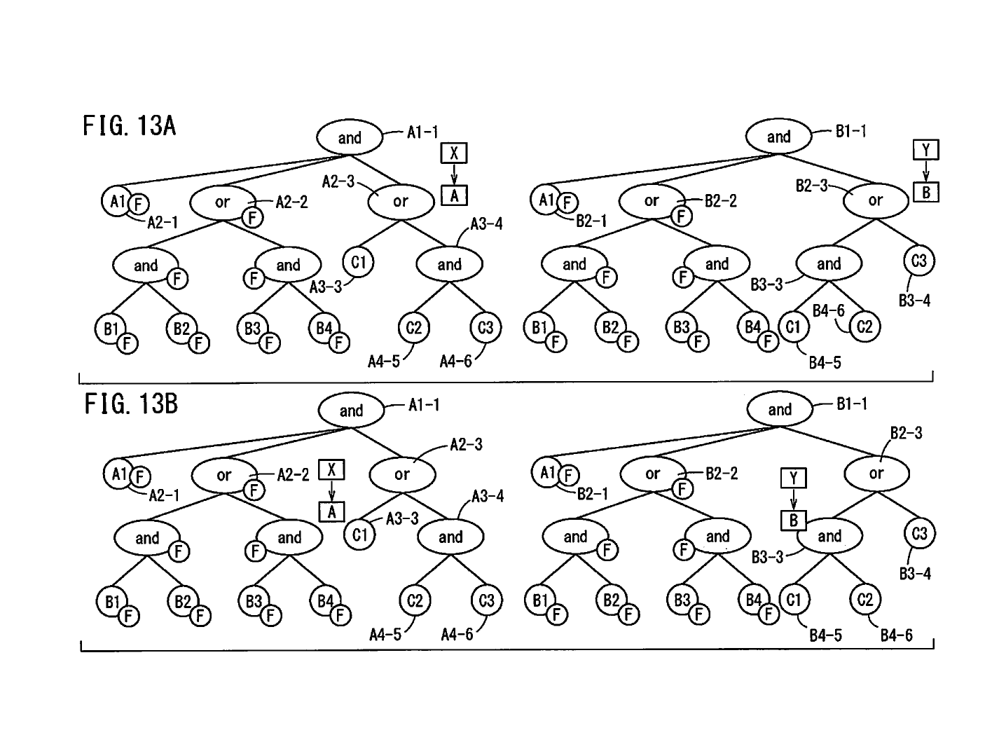

After the logical expression comparison processing has ended on node A2-2 and its lower-level nodes and node B2-2 and its lower-level nodes, processing proceeds in the manner of step S38→step S41, and after node A2-2 and its lower-level nodes and node B2-2 and its lower-level nodes have been assigned with the comparison-completed mark, node A2-3 is set to target node X, and node B2-3 is set to target node Y (FIG. 13A). Since target node X and target node Y have been set, processing proceeds in the manner of step S42→step S37, and a recursive call of the logical expression comparison processing assuming target node A to be node A2-3 and target node B to be node B2-3, is made (FIG. 13A).

Since node A2-3 and node B2-3 are both the operator “or”, processing proceeds in the manner of step S31→step S33→step S36. In step S36, the comparison-completed marks of all of the sub-nodes of node A2-3 and node B2-3 are deleted, then node A3-3 is set to target node X, and node B3-3 is set to target node Y (FIG. 13B). In following step S37, a recursive call of the logical expression comparison processing is made assuming target node A to be node A3-3 and target node B to be node B3-3 (FIG. 13B).

Since the kind of the node A3-3 is a signal, whereas the kind of the node B3-3 is an operator, processing proceeds in the manner of step S31→step S32. In step S32, the non-matching flag is raised, and in following step S47, that non-matching flag is returned as a return value.

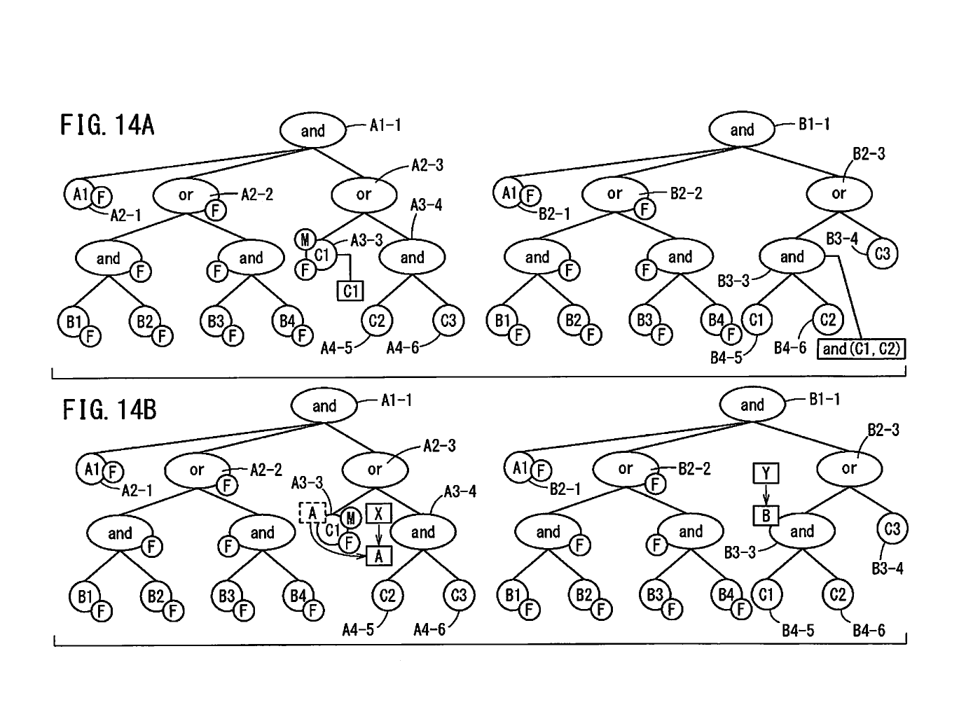

When the logical expression comparison processing assuming target node A to be node A3-3 and target node B to be node B3-3 ends, processing proceeds to step S38. At this time, the non-matching flag is in a raised state, so processing proceeds to step S39. In step S39, the name “C1” of node A3-3 being target node X and the name “and (C1, C2)” of node B3-3 being target node Y are compared with each other, and node A3-3 which is ahead in the name order is assigned with the non-matching mark and the comparison-completed mark (FIG. 14A).

In following step S40, node A3-4 being the next node of the non-matching-mark-assigned node A3-3, is set to target node X (FIG. 14B). Since target node X and target node Y have been set, processing proceeds in the manner of step S42→step S37, and a recursive call of the logical expression comparison processing is made assuming target node A to be node A3-4 and target node B to be node B3-3 (FIG. 14B).

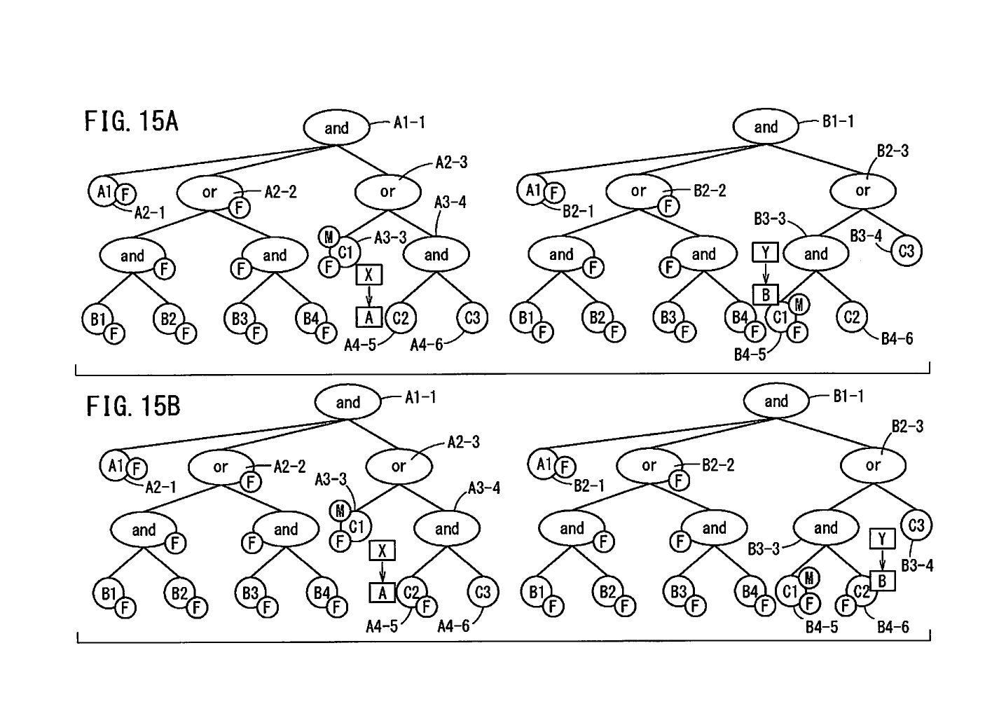

Since node A3-4 and node B3-3 are both the operator “and”, processing proceeds in the manner of step S31→step S33→step S36, and after the comparison-completed marks of the sub-nodes of node A3-4 and node B3-3 have been deleted, node A4-5 is set to target node X, and node B4-5 is set to target node Y (FIG. 15A). In following step S37, a recursive call of the logical expression comparison processing is made assuming target node A to be node A4-5 and target node B to be node B4-5 (FIG. 15A).

When the logical expression comparison processing assuming target node A to be node A4-5 and target node B to be node B4-5 ends, processing proceeds to step S38. At this time, the non-matching flag is in a raised state, so processing proceeds to step S39. The name “C2” of node A4-5 being target node X and the name “C1” of node B4-5 being target node Y are compared, and node B4-5 is assigned with the non-matching mark and the comparison-completed mark (FIG. 15A).

In following step S40, node B4-6 being the next node of the non-matching-mark-assigned node B4-5, is set to target node Y (FIG. 15B). Since target node X and target node Y have been set, processing proceeds in the manner of step S42 step S37, and a recursive call of the logical expression comparison processing is made assuming target node A to be node A4-5 and target node B to be node B4-6 (FIG. 15B).

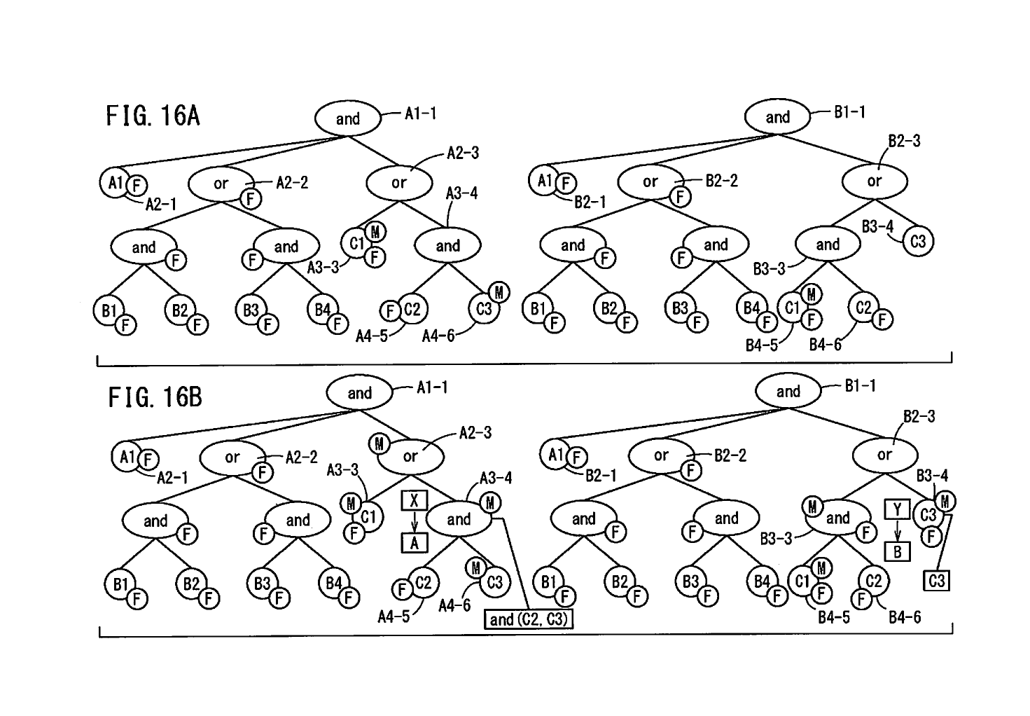

Since node A4-5 and node B4-6 match and thus the non-matching flag is not raised, processing proceeds in the manner of step S38 step S41, and node A4-5 and node B4-6 are assigned with the comparison-completed mark (FIG. 15B). Then, since although node A4-6 is set to target node X, there is no next node of node B4-6 for target node Y, processing proceeds in the manner of step S42→step S43. Since in step S43, node A4-6, of the sub-nodes of node A3-4 and node B3-3, becomes a non-processed node by not having the comparison-completed mark, then, in step S44, node A4-6 is assigned with the non-matching mark, and processing proceeds in the manner of step S45→step S47 (FIG. 16A).

When the logical expression comparison processing ends on node A3-4 and its lower-level nodes and node B3-3 and its lower-level nodes, node B4-5 and node A4-6 are newly assigned with the non-matching mark (FIG. 16A). At this time, the non-matching flag is in a raised state, so processing proceeds in the manner of step S38→step S39, and node B3-3 is assigned with the non-matching mark and the comparison-completed mark. Then, a recursive call of the logical expression comparison processing is made assuming target node A to be node A3-4 and target node B to be node B3-4 (FIG. 16B).

Since the kind of the node A3-4 is an operator, whereas the kind of the node B3-4 is a signal, processing proceeds in the manner of step S31→step S32. In step S32, the non-matching flag is raised, and in following step S47, that non-matching flag is returned as a return value.

When the logical expression comparison processing assuming target node A to be node A3-4 and target node B to be node B3-4 ends, processing proceeds to step S38. At this time, the non-matching flag is in a raised state, so processing proceeds to step S39. In step S39, the name “and (C2, C3)” of node A3-4 being target node X and the name “C3” of node B3-4 being target node Y are compared, and node B3-4 which is ahead in the name order is assigned with the non-matching mark and the comparison-completed mark (FIG. 16B). In following step S40, since there does not exist a next node of the non-matching-mark-assigned node B3-4, target node Y cannot be set. Therefore, processing proceeds in the manner of step S40→step S42→step S43.

Node A3-4 becomes a non-processed node, since by not being assigned with the comparison-completed mark, its logical expression comparison processing is incomplete. Therefore, in step S44, node A3-4 is assigned with the non-matching mark, in step S45, the non-matching flag is raised, and in following step S47, that non-matching flag is returned as a return value (FIG. 16B).

When all the logical expression comparison processing for which a recursive call has been made ends, it results in a state where the non-matching marks are assigned respectively to node A2-3, node A3-3, node A3-4, node A4-6, node B3-3, node B3-4, and node B4-5 (FIG. 16B).

### [Operational Advantages]

Conventionally, when comparing two programs described by ladder diagrams, it has been judged whether or not structures of ladder circuits match. However, in this method of judging, even substantively identical ladder circuits that although structures of the ladder circuits differ, outputs with respect to a signal inputted to the ladder circuits match, are judged to be non-matching. Since ladder circuits that have been judged non-matching need to undergo testing, and so on, there has been a risk of unnecessary work increasing.

Accordingly, in the present embodiment, a configuration has been adopted whereby first, the ladder circuits of two comparison target ladder programs are converted into logical expressions, and the order of variables of those logical expressions is rearranged so that the result does not change, thereby creating comparison-oriented logical expressions. Moreover, a configuration has been adopted whereby fellow comparison-oriented logical expressions are then compared, and it is judged whether or not they match. As a result, ladder circuits that although structures of the ladder circuits differ, outputs with respect to a signal inputted to the ladder circuits match, can be judged to be matching.

Moreover, in the present embodiment, a configuration has been adopted whereby in the ladder circuits displayed in the display unit 24, a place corresponding to part of the expressions that was non-matching of the two compared comparison-oriented logical expressions, is highlighted. As a result, places that differ, of the ladder circuits of two comparison target ladder programs can be displayed in the display unit 24 such that they are easily recognized by a user. Moreover, a ladder circuit created from the comparison-oriented logical expression may be used as the ladder circuit displayed in the display unit 24. As a result, the structure of the ladder circuit is neatly rearranged, and content of non-matching places is clarified.

### MODIFIED EXAMPLE 1

In the first embodiment, the logical expression of the ladder circuit of the comparison-base ladder program and the logical expression of the ladder circuit of the comparison-object ladder program were both converted into respective comparison-oriented logical expressions, and fellow comparison-oriented logical expressions were compared. In contrast, a configuration may be adopted whereby all possible comparison-oriented logical expressions of the ladder circuit of one of the ladder programs are generated through conversion processing in which the order of the variables is rearranged in all possible patterns so as not to change the result of the logical expression, and the logical expression of the ladder circuit of the other of the ladder programs is compared with the comparison-oriented logical expression of the ladder circuit of the one of the ladder programs every time one of the possible comparison-oriented logical expressions is generated through the conversion processing.

### MODIFIED EXAMPLE 2

In addition to the first embodiment, a configuration may be adopted whereby a library is created for a matching ladder circuit, of the ladder circuit of the comparison-base ladder program and the ladder circuit of the comparison-object ladder program.

### MODIFIED EXAMPLE 3

In addition to the first embodiment, a configuration may be adopted whereby refactoring is performed on a ladder circuit that matches a ladder circuit of the comparison-base ladder program, of the ladder circuits of the comparison-object ladder program, so that the ladder circuit of the comparison-object ladder program is matched to the structure of the ladder circuit of the matching comparison-base ladder program.

Note that a configuration may be adopted whereby refactoring is performed on a ladder circuit that matches a ladder circuit of the comparison-object ladder program, of the ladder circuits of the comparison-base ladder program, so that the ladder circuit of the comparison-base ladder program is matched to the structure of the ladder circuit of the matching comparison-object ladder program.

### MODIFIED EXAMPLE 4

Although the first embodiment showed an example performing a comparison of the comparison-base ladder program and the comparison-object ladder program, the present invention can be applied also to comparing two ladder circuits in one ladder program.

### Technical Concepts Obtained from Embodiment

Technical concepts understandable from the above-described embodiment will be described below.

The program comparing device (10) that compares programs described by ladder diagrams, includes: the logical expression converting unit (14) configured to convert a ladder circuit of the program into a logical expression, in units of the ladder circuit; the order converting unit (26) configured to rearrange an order of signals of the logical expression of at least one ladder circuit, of two of the ladder circuits that are comparison targets, so as not to change a result of the logical expression; and the comparing unit (18) configured to compare the logical expression of the one ladder circuit after the order of the signals has been rearranged, with a logical expression of the other ladder circuit of the two of the ladder circuits, and judge whether or not the logical expression of the one ladder circuit and the logical expression of the other ladder circuit match. As a result, two ladder circuits that are substantively identical although their structures differ, can be judged to be identical.

In the above-described program comparing device (10), the order converting unit (26) may rearrange the order of the signals of the logical expression of each of the two of the ladder circuits that are comparison targets, so as not to change the result of the logical expression, according to a certain rule, and the comparing unit (18) may compare the logical expression of one of the ladder circuits after the order of the signals has been rearranged, with the logical expression of the other of the ladder circuits after the order of the signals has been rearranged. Thus, by rearranging the order in the logical expression of each of two ladder circuits according to the same certain rule, it becomes easy to judge whether or not two ladder circuits match.

In the above-described program comparing device (10), the order converting unit (26) may generate all possible logical expressions of the one ladder circuit of the two of the ladder circuits that are comparison targets, by rearranging the order of the signals of the logical expression so as not to change the result of the logical expression, and the comparing unit (18) may compare the logical expression of the one ladder circuit after the order of the signals has been rearranged, with the logical expression of the other ladder circuit, every time one of the possible logical expressions of the one ladder circuit is generated by rearranging the order of the signals of the logical expression of the one ladder circuit. Thus, by rearranging the order in the logical expression of one ladder circuit in all possible patterns, it becomes easy to judge whether or not two ladder circuits match.

The above-described program comparing device (10) may further include the display control unit (20) configured to, when it has been judged by the comparing unit (18) that the logical expression of the one ladder circuit and the logical expression of the other ladder circuit do not match, cause information of a non-matching place in the ladder circuits to be displayed in the display unit (24). As a result, places that differ in the ladder circuits can be displayed in the display unit (24) such that they are easily recognized by a user.

In the above-described program comparing device (10), the one ladder circuit may be a ladder circuit of one program of two of the programs, and the other ladder circuit may be a ladder circuit of the other program of the two of the programs. As a result, it can be judged whether or not two programs match.

In the above-described program comparing device (10), the comparing unit (18) may compare the logical expression of the ladder circuit of the one program with the logical expression of the ladder circuit of the other program corresponding to the ladder circuit of the one program. As a result, it can be judged whether or not two programs match.

A program comparing method that compares programs described by ladder diagrams, includes: a logical expression converting step of converting a ladder circuit of the program into a logical expression, in units of the ladder circuit; an order converting step of rearranging an order of signals of the logical expression of at least one ladder circuit, of two of the ladder circuits that are comparison targets, so as not to change a result of the logical expression; and a comparing step of comparing the logical expression of the one ladder circuit after the order of the signals has been rearranged, with a logical expression of the other ladder circuit, and judging whether or not the logical expression of the one ladder circuit and the logical expression of the other ladder circuit match. As a result, two ladder circuits that are substantively identical although their structures differ, can be judged to be identical.

In the above-described program comparing method, the order converting step may rearrange the order of the signals of the logical expression of each of the two of the ladder circuits that are comparison targets, so as not to change the result of the logical expression, according to a certain rule, and the comparing step may compare the logical expression of one of the ladder circuits after the order of the signals has been rearranged, with the logical expression of another of the ladder circuits after the order of the signals has been rearranged. Thus, by rearranging the order in the logical expression of each of two ladder circuits according to the same certain rule, it becomes easy to judge whether or not two ladder circuits match.

In the above-described program comparing method, the order converting step may generate all possible logical expressions of the one ladder circuit of the two of the ladder circuits that are comparison targets, by rearranging the order of the signals of the logical expression so as not to change the result of the logical expression, and the comparing step may compare the logical expression of the one ladder circuit after the order of the signals has been rearranged, with the logical expression of the other ladder circuit, every time one of the possible logical expressions of the one ladder circuit is generated by rearranging the order of the signals of the logical expression of the one ladder circuit. Thus, by rearranging the order in the logical expression of one ladder circuit in all possible patterns, it becomes easy to judge whether or not two ladder circuits match.

The above-described program comparing method may further include a display control step of, when it has been judged by the comparing step that the logical expression of the one ladder circuit and the logical expression of the other ladder circuit do not match, causing information of a non-matching place in the ladder circuits to be displayed in the display unit (24). As a result, places that differ in the ladder circuits can be displayed in the display unit (24) such that they are easily recognized by a user.

In the above-described program comparing method, the one ladder circuit may be a ladder circuit of one program of two of the programs, and the other ladder circuit may be a ladder circuit of another program of the two of the programs. As a result, it can be judged whether or not two programs match.

In the above-described program comparing method, the comparing step may compare the logical expression of the ladder circuit of the one program with the logical expression of the ladder circuit of the other program corresponding to the ladder circuit of the one program. As a result, it can be judged whether or not two programs match.

The present invention is not particularly limited to the embodiments described above, and various modifications are possible without departing from the essence and gist of the present invention.

What is claimed is:

1. A program comparing device that compares programs described by ladder diagrams, comprising:
a logical expression converting unit configured to convert a ladder circuit of the program into a logical expression, in units of the ladder circuit;
an order converting unit configured to rearrange an order of signals of the logical expression of at least one ladder circuit, of two of the ladder circuits that are comparison targets, so as not to change a result of the logical expression; and
a comparing unit configured to compare the logical expression of the one ladder circuit after the order of the signals has been rearranged, with a logical expression of another ladder circuit of the two of the ladder circuits, and judge whether or not the logical expression of the one ladder circuit and the logical expression of the other ladder circuit match.

2. The program comparing device according to claim 1, wherein
the order converting unit rearranges the order of the signals of the logical expression of each of the two of the ladder circuits that are comparison targets, so as not to change the result of the logical expression, according to a certain rule, and
the comparing unit compares the logical expression of one of the ladder circuits after the order of the signals has been rearranged, with the logical expression of another of the ladder circuits after the order of the signals has been rearranged.

3. The program comparing device according to claim 1, wherein
the order converting unit generates all possible logical expressions of the one ladder circuit of the two of the ladder circuits that are comparison targets, by rearranging the order of the signals of the logical expression so as not to change the result of the logical expression, and
the comparing unit compares the logical expression of the one ladder circuit after the order of the signals has been rearranged, with the logical expression of the other ladder circuit, every time one of the possible logical expressions of the one ladder circuit is generated by rearranging the order of the signals of the logical expression of the one ladder circuit.

4. The program comparing device according to claim 1, further comprising a display control unit configured to, when it has been judged by the comparing unit that the logical expression of the one ladder circuit and the logical expression of the other ladder circuit do not match, cause information of a non-matching place in the ladder circuits to be displayed in a display unit.

5. The program comparing device according to claim 1, wherein
the one ladder circuit is a ladder circuit of one program of two of the programs, and
the other ladder circuit is a ladder circuit of another program of the two of the programs.

6. The program comparing device according to claim 5, wherein
the comparing unit compares the logical expression of the ladder circuit of the one program with the logical expression of the ladder circuit of the other program corresponding to the ladder circuit of the one program.

7. A program comparing method that compares programs described by ladder diagrams, comprising:
a logical expression converting step of converting a ladder circuit of the program into a logical expression, in units of the ladder circuit;
an order converting step of rearranging an order of signals of the logical expression of at least one ladder circuit, of two of the ladder circuits that are comparison targets, so as not to change a result of the logical expression; and
a comparing step of comparing the logical expression of the one ladder circuit after the order of the signals has been rearranged, with a logical expression of another ladder circuit of the two of the ladder circuits, and judging whether or not the logical expression of the one ladder circuit and the logical expression of the other ladder circuit match.

8. The program comparing method according to claim 7, wherein
the order converting step rearranges the order of the signals of the logical expression of each of the two of the ladder circuits that are comparison targets, so as not to change the result of the logical expression, according to a certain rule, and
the comparing step compares the logical expression of one of the ladder circuits after the order of the signals has been rearranged, with the logical expression of another of the ladder circuits after the order of the signals has been rearranged.

9. The program comparing method according to claim 7, wherein
the order converting step generates all possible logical expressions of the one ladder circuit of the two of the ladder circuits that are comparison targets, by rearranging the order of the signals of the logical expression so as not to change the result of the logical expression, and
the comparing step compares the logical expression of the one ladder circuit after the order of the signals has been rearranged, with the logical expression of the other ladder circuit, every time one of the possible logical expressions of the one ladder circuit is generated by rearranging the order of the signals of the logical expression of the one ladder circuit.

10. The program comparing method according to claim 7, further comprising a display control step of, when it has been judged by the comparing step that the logical expression of the one ladder circuit and the logical expression of the other ladder circuit do not match, causing information of a non-matching place in the ladder circuits to be displayed in a display unit.

11. The program comparing method according to claim 7, wherein
the one ladder circuit is a ladder circuit of one program of two of the programs, and
the other ladder circuit is a ladder circuit of another program of the two of the programs.

12. The program comparing method according to claim 11, wherein
the comparing step compares the logical expression of the ladder circuit of the one program with the logical expression of the ladder circuit of the other program corresponding to the ladder circuit of the one program.
